(19) United States
(12) Patent Application Publication
(10) Pub. No.: US 2026/0252904 A1
(43) Pub. Date: Aug. 27, 2026

(54) SCALABLE MACHINE LEARNING PLATFORM WITH INTEGRATED FEATURE GENERATION AND REAL-TIME MODEL SERVING

(71) Applicant: Snap Inc., Santa Monica, CA (US)

(72) Inventors: Mehdi Drissi, Mountain View, CA (US); Hassan Eslami, Bellevue, WA (US); Saral Jain, Bellevue, WA (US); Chunsheng Ji, Saratoga, CA (US); Xu Ning, Seattle, WA (US); Mikhail Obukhov, Fremont, CA (US); Prateek Patel, Seattle, WA (US); Dmitry Sigaev, San Francisco, CA (US); Oleg Solovey, Los Angeles, CA (US); Liang Wei, San Jose, CA (US); Yilun Xu, Santa Clara, CA (US); Yin Ye, Santa Clara, CA (US); Jingping Yuan, San Jose, CA (US)

(21) Appl. No.: 19/461,296

(22) Filed: Jan. 27, 2026

Related U.S. Application Data
(60) Provisional application No. 63/750,479, filed on Jan. 28, 2025.

(51) Int. Cl. G06N 3/0985; G06N 20/00

(52) U.S. Cl. CPC G06N 3/0985; G06N 20/00

(57) ABSTRACT

A system and method for machine learning platform management includes a unified architecture for developing and deploying machine learning models at scale. The platform integrates feature generation, model training, and inference services through a centralized interface. The system processes source data through a feature platform to generate training datasets and real-time features. A multi-stage training pipeline enables automated model experimentation through configurable workflows combining core frameworks and user modeling code. The platform implements specialized inference services optimized for high-throughput ranking and recommendation use cases, with distributed feature stores and local caching for efficient feature serving. A comprehensive monitoring system tracks model performance, feature distributions, and prediction quality through automated anomaly detection. The platform enables rapid experimentation while maintaining production reliability through automated deployment orchestration, optimized inference engines, and continuous feedback loops for model improvement.

### CROSS REFERENCE TO RELATED APPLICATIONS

This application claims the benefit of and priority to U.S. Provisional Patent Application No. 63/750,479, filed Jan. 28, 2025, and entitled “SCALABLE MACHINE LEARNING PLATFORM WITH INTEGRATED FEATURE GENERATION AND REAL-TIME MODEL SERVING,” the entire contents of which are hereby incorporated by reference in their entirety.

### TECHNICAL FIELD

The present disclosure relates generally to machine learning platform technologies, and more particularly to systems and methods for managing large-scale machine learning operations in distributed computing environments. Specifically, the subject matter described herein pertains to an integrated machine learning platform that enables end-to-end management of feature generation, model training, and high-throughput inference serving, with particular emphasis on optimizing real-time ranking and recommendation systems processing billions of predictions per second while maintaining data freshness and operational efficiency. The technology includes specialized feature store architectures, optimized inference engines, and automated model lifecycle management capabilities designed to handle petabyte-scale training data and support complex production ML workloads across cloud-based infrastructure.

### BACKGROUND

Machine learning (ML) has become a cornerstone of modern computing, providing a foundation for developing intelligent systems capable of learning patterns from data and making predictions or decisions. Among its diverse applications, ML has been widely adopted for designing recommendation systems, which analyze user preferences and behavior to deliver personalized suggestions. These systems are essential for a variety of digital platforms, including e-commerce, media streaming services, and social networks.

Recommendation systems operate by leveraging advanced machine learning models and algorithms to analyze large datasets, often integrating user-specific data such as browsing history, purchase records, and social interactions. These systems frequently utilize collaborative filtering, content-based filtering, or hybrid approaches to identify relevant items for users, enhancing their experience by presenting tailored content or advertisements. The implementation of such systems typically involves complex processes, including data preprocessing, feature extraction, model training, and evaluation.

The development and testing of recommendation systems often require seamless integration with existing software applications, as well as compatibility with various machine learning frameworks. As the landscape of machine learning evolves, application developers face challenges in adopting and utilizing these frameworks efficiently, particularly when aiming to optimize recommendation performance while maintaining scalability and flexibility. Platforms that streamline this integration process play a critical role in enabling the rapid creation and deployment of effective recommendation systems.

### BRIEF DESCRIPTION OF THE DRAWINGS

In the drawings, which are not necessarily drawn to scale, like numerals may describe similar components in different views. To easily identify the discussion of any particular element or operation, the most significant digit or digits in a reference number refer to the figure number in which that element is first introduced. Some non-limiting examples are illustrated in the figures of the accompanying drawings in which:

FIG. 1 is a system architecture diagram illustrating components of a machine learning platform including data sources, training data generation, model training, and inference services, consistent with some embodiments.

FIG. 2 is a diagram depicting a feature generation and training data preparation workflow for content recommendation use cases, according to some embodiments.

FIG. 3 is a flowchart illustrating steps of a model training pipeline including training data generation, model training, automated hyperparameter tuning, model evaluation and validation, and model export phases, consistent with some embodiments.

FIG. 4 is a user interface screenshot showing a training workflow visualization with multiple processing stages and dependencies displayed as a directed acyclic graph, according to some embodiments.

FIG. 5 is a diagram illustrating an inference service architecture with a two-part feature store design that separates user feature retrieval from document feature hydration, consistent with some embodiments.

FIG. 6 is a diagram showing a retrieval system architecture for processing user requests through business logic, distributed retrieval with multiple indexing components, and inference stages, according to some embodiments.

FIG. 7 is a user interface screenshot depicting a model monitoring dashboard showing performance metrics including throughput, latency, and model version tracking for production inference services, consistent with some embodiments.

FIG. 8 is a diagram illustrating a monitoring system architecture for tracking online predictions and features, including anomaly detection and online/offline discrepancy monitoring, according to some embodiments.

FIG. 9 is a diagram illustrating a content ranking workflow incorporating a two-stage machine learning pipeline with lightweight and complex models, consistent with some embodiments.

FIG. 10 is a block diagram illustrating a software architecture that may be used to implement aspects of the machine learning platform, according to some embodiments.

FIG. 11 is a block diagram illustrating a hardware architecture that may be used to implement aspects of the machine learning platform, consistent with some embodiments.

### DETAILED DESCRIPTION

The present disclosure relates to systems and methods for managing large-scale machine learning operations through an integrated platform architecture. The following detailed description is presented to enable any person skilled in the art to make and use the disclosed embodiments. For purposes of explanation, specific details are set forth describing systems and methods for feature generation, model training, and high-throughput inference serving in distributed computing environments. Various modifications to the embodiments will be readily apparent to those skilled in the art, and the general principles defined herein may be applied to other embodiments and applications without departing from the scope of the disclosure. The platform described herein enables processing of petabyte-scale datasets and billions of real-time predictions while maintaining operational efficiency and data freshness across diverse machine learning applications. Thus, the present disclosure is not intended to be limited to the embodiments shown, but is to be accorded the widest scope consistent with the principles and features disclosed herein.

Embodiments of the present disclosure address technical problems that have prevented conventional machine learning infrastructure from efficiently supporting large-scale production workloads, particularly real-time ranking and recommendation systems that must process billions of predictions per second while maintaining low latency, high feature freshness, and cost efficiency. These challenges include: the architectural inability of existing systems to manage end-to-end ML workflows spanning feature generation, model training, and inference serving within a unified platform; the excessive latency and operational costs incurred during high-fanout inference operations where ranking requests must score large numbers of candidate documents against user context features; the lack of automated mechanisms for incremental model training, validation, and deployment that can maintain prediction accuracy as new data continuously arrives; the absence of integrated monitoring systems capable of detecting anomalies in feature distributions and prediction outputs while identifying discrepancies between online serving behavior and offline model evaluation; and the substantial duplicate engineering effort required by product teams to integrate disparate ML building blocks—including big data processing frameworks, ML training libraries, workflow orchestration engines, and cloud infrastructure services—into production-ready systems capable of delivering personalized experiences to hundreds of millions of daily active users.

Conventional approaches to machine learning systems face significant technical limitations that impede the effective deployment and management of production ML workloads. In typical prior art implementations, organizations assemble machine learning capabilities by combining open-source software components and cloud provider services, such as distributed data processing frameworks for feature engineering, separate ML training frameworks for model development, independent workflow orchestration tools for pipeline management, and distinct serving infrastructure for production inference. While these individual building blocks provide basic ML functionality, their fragmented nature creates substantial integration overhead and prevents the holistic optimizations necessary for high-scale applications. Product teams using conventional approaches must independently develop custom integrations between each component, resulting in duplicated engineering effort across the organization and inconsistent implementations that are difficult to maintain and evolve.

Traditional systems suffer from several critical technical deficiencies in feature management and serving. In conventional architectures, features computed during offline training are stored separately from features required for online inference, typically in disparate storage systems with different access patterns and freshness guarantees. When a ranking or recommendation request arrives in such systems, the inference layer must issue multiple network calls to retrieve both user-specific features and document-specific features from centralized feature stores. For high-fanout scenarios—where a single ranking request may require scoring hundreds or thousands of candidate documents against a user context—this architecture results in a combinatorial explosion of feature retrieval operations. Each document requires a separate feature lookup, and the aggregate latency of these distributed calls dominates the overall request processing time. Furthermore, the network bandwidth consumed by transmitting feature data between the centralized store and the inference engine represents a significant operational cost that scales linearly with prediction volume.

Prior art solutions also lack robust mechanisms for model lifecycle management and quality assurance. In conventional systems, the processes of training data generation, model training, model evaluation, and model deployment are managed through separate tools with minimal integration. Engineers must manually orchestrate the flow of data and artifacts between these stages, configure incremental training schedules, and coordinate deployment decisions based on evaluation metrics. This manual orchestration introduces delays in the model update cycle and increases the risk of errors during deployment. Additionally, existing systems do not provide unified monitoring capabilities that span the entire ML pipeline. Feature drift—where the statistical distribution of input features changes over time—may go undetected until model performance degrades significantly. Similarly, discrepancies between model behavior during offline evaluation and online serving, which can arise from subtle differences in feature computation or data preprocessing, are difficult to identify and diagnose without specialized instrumentation that conventional systems lack.

The technical problems are particularly acute in social media and content delivery platforms, where the scale and latency requirements of personalization applications exceed the design assumptions of readily available ML software and services. Such platforms must deliver personalized content recommendations, friend suggestions, and targeted advertisements to hundreds of millions of daily active users, with each user session potentially generating multiple ranking requests per second. The candidate pools for these ranking operations may contain millions of items, and the models must incorporate features that reflect user behavior from seconds or minutes ago to maintain relevance. Conventional ML infrastructure cannot efficiently handle the combination of high request volume, large candidate sets, strict latency budgets, and real-time feature freshness requirements that characterize these applications. The cumulative effect of these limitations—fragmented tooling, inefficient feature serving, manual lifecycle management, and inadequate monitoring—prevents organizations from fully realizing the value of machine learning in production environments and creates significant barriers to ML adoption and experimentation.

To address these technical challenges, embodiments described in the present disclosure provide an integrated machine learning platform that enables unprecedented scale and efficiency in managing complex ML workloads across distributed computing environments.

The disclosed platform implements a novel architecture that seamlessly integrates feature generation, model training, and high-throughput inference serving. The platform's innovative two-part feature store architecture separates user features into a distributed key-value store while co-locating document features with the inference engine, dramatically reducing network calls and improving throughput. This architectural approach enables processing of billions of predictions per second while maintaining low latency, representing a significant advancement over conventional systems.

The platform further provides substantial technical advantages through its automated workflow management capabilities. The system incorporates specialized components for incremental training, model validation, and deployment orchestration that eliminate the duplicate engineering effort required by traditional approaches. Additionally, the platform's monitoring system provides unprecedented visibility into model performance through automated anomaly detection for features and predictions, tracking of online/offline discrepancies, and comprehensive quality assurance capabilities.

The platform demonstrates several key technical advantages over prior art solutions, including: (1) the ability to handle petabyte-scale training datasets and process over a billion predictions per second, (2) optimization techniques that achieve 2× lower latency and 10× reduced dataplane costs compared to conventional approaches, (3) automated workflows that enable thousands of model experiments per month, and (4) integrated monitoring capabilities that ensure model quality and performance in production environments. These innovations enable organizations to deploy and manage machine learning workloads at scales previously unattainable with conventional solutions. Other aspects and advantages of the various embodiments will be readily apparent from the description of the several figures that follows.

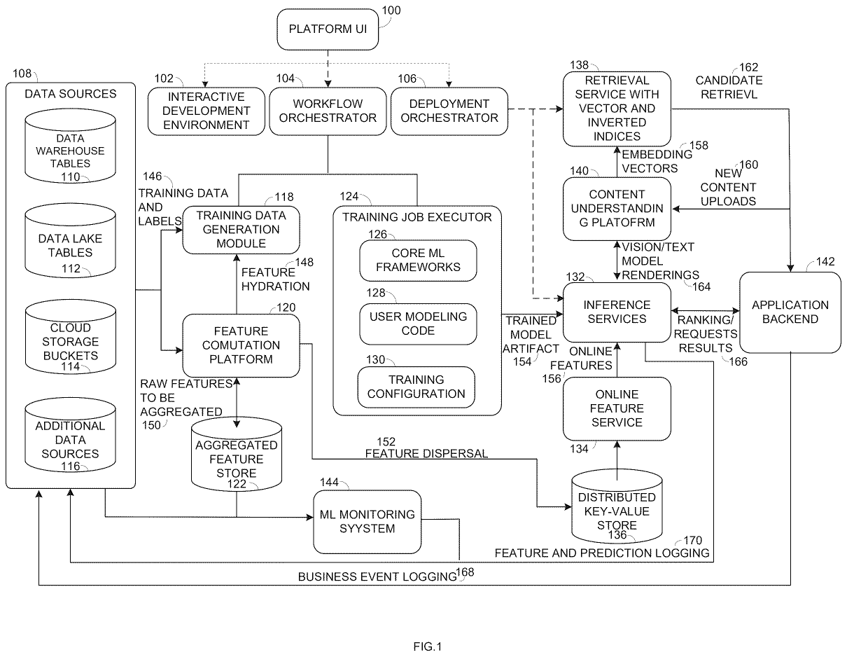

FIG. 1 is a system architecture diagram illustrating components of a machine learning platform 100 including data sources 108, training data generation, model training, and inference services 132, consistent with some embodiments. The machine learning platform 100 is instrumental in curating personalized content, formulating recommendations, and delivering targeted content to platform users across diverse application domains including content ranking, friend suggestions, and advertisement delivery.

The machine learning platform 100 facilitates diverse ML applications at scale and optimizes model experimentation and productionization lifecycle. The platform 100 seamlessly handles the end-to-end ML development lifecycle, spanning feature and training data generation, model training and management, and model deployment in various configurations. Since its implementation, the platform 100 has significantly boosted ML engineering efficiency, enabling engineers to perform thousands of different model experiments in a month while supporting production systems capable of processing billions of predictions per second.

While ML technology building blocks are widely accessible through open-source software and cloud providers, the disclosed platform 100 provides several key technical advantages through its integrated architecture. First, it delivers an end-to-end experience by combining building blocks such as big data technologies, ML frameworks, workflow engines, and cloud services to present one centralized, seamless ML development experience through a platform user interface 100. Second, it provides specialization by optimizing systems for high-scale tasks like ranking and recommendation, where the scale often surpasses the design assumptions of many readily available software and services. The platform 100 achieves significant performance improvements including reduced latency and lower dataplane costs compared to conventional approaches through architectural optimizations described herein.

The platform 100 further provides integration benefits by eliminating duplicate effort that product teams need to perform to integrate with internal technology stacks by providing this ML platform layer to productionize all ML workloads. Additionally, the platform 100 enables focused support through dedicated platform engineers who can design the system to cater to unique needs, development styles, and release workflows of ML application teams. The unified architecture enables organizations to manage petabyte-scale training datasets and serve hundreds of millions of daily active users with personalized predictions.

As illustrated in FIG. 1, the platform architecture comprises four major components: (1) Feature and Training Data Generation, (2) Model Training, (3) ML Production, and (4) UI, Control Plane and Monitoring. The platform 100 is built on a combination of cloud services, open-source software, and proprietary technologies. These components work together to accelerate ML adoption and experimentation by providing a scalable and efficient solution, focusing on two main technical challenges: ML development throughput and production scalability.

As illustrated in FIG. 1, the machine learning platform 100 comprises several key components that work together to enable end-to-end ML operations. The platform user interface 100 provides a centralized interface through which ML engineers can explore features and construct datasets, edit, launch, and monitor training workflows, visualize metrics for trained models and manage experiments, deploy models and retrieval indexes to production, set up and schedule incremental training, and monitor features, predictions, and operating costs. The platform user interface 100 integrates with an interactive development environment 102 that enables engineers to develop and test model code, a workflow orchestration module 104 that manages the execution of multi-step ML pipelines, and a deployment orchestration module 106 that coordinates model deployment to production inference services 132.

The data sources 108 provide the raw input for feature generation and model training. The platform 100 ingests data from multiple sources including data warehouse tables 110, data lake tables 112, cloud storage buckets 114, and additional data sources 116. The data warehouse tables 110 may comprise columnar data stores optimized for analytical queries, while the data lake tables 112 may comprise open table formats that support both batch and streaming data access. The cloud storage buckets 114 provide scalable object storage for large datasets, model artifacts, and intermediate processing results. These diverse data sources 108 collectively provide the foundation for feature computation and training data assembly.

The feature computation platform 120 processes raw data to generate features for ML models. The feature computation platform 120 receives raw features to be aggregated 150 from the data sources 108 and generates aggregated features by processing event data streams over sliding time windows and grouping by entity keys such as user identifiers and content identifiers. The aggregated features are stored in an aggregated feature store 122, which may comprise data lake tables for offline training purposes, and are disseminated through a feature dispersal process 152 to a distributed key-value store 136 for online inference serving. This dual-storage architecture ensures that features computed for training are consistent with features served during inference, while enabling each storage system to be optimized for its respective access patterns. The training data generation module 118 combines the aggregated features with training labels 146 to create training datasets suitable for consumption by model training processes.

The training job executor 124 comprises the infrastructure for model training and consists of three composable layers that enable efficient experimentation and code reuse. The core ML frameworks 126 encapsulate machine learning libraries and standardize modeling techniques and components for recommendation use cases, such as deep cross networks and transformers. This standardization enables ML engineers to experiment efficiently with various feature implementations and promotes code sharing across teams. The model implementation code 128 layer enables engineers to express specific model architectures by authoring custom code that leverages the abstractions provided by the core ML frameworks 126. The training configuration 130 comprises configuration files that specify how training jobs should be executed, including hardware type, input and output data locations, and runtime options that determine training behavior. This layered structure facilitates rapid experimentation by enabling engineers to modify job configurations without changing model code. The training job executor 124 produces a trained model artifact 154 that is prepared for deployment to inference services 132.

The inference services 132 handle model serving for real-time predictions and work in conjunction with the online feature service 134 and the distributed key-value store 136 to enable high-throughput inference. In accordance with some embodiments, when the inference services 132 receive an inference request comprising a user identifier and a plurality of candidate content identifiers specifying a ranking operation, the system retrieves a set of user features from the distributed key-value store 136. The distributed key-value store 136 is communicatively coupled to the feature computation platform 120, which generates the aggregated features from event data streams. The inference services 132 transmit the inference request and user features to an inference engine instance, where document features for each candidate content identifier are hydrated by accessing a local feature store co-located with the inference engine instance. This architectural approach enables the hydrating to be performed without issuing network calls to the distributed key-value store 136 for document feature retrieval, thereby substantially reducing latency and operational costs in high-fanout ranking scenarios. The inference services 132 execute trained machine learning models to generate relevance scores for each candidate content identifier and return the scores in response to the inference request.

The retrieval services with vector and inverted indexes 138 implement approximate nearest neighbor indexes, inverted indexes, and forward indexes for efficient document retrieval and feature hydration. The retrieval services 138 function as a comprehensive document retrieval system that enables flexible, single-pass retrieval and hydration queries capable of returning relevant documents along with their associated features. This approach is particularly suitable for use cases involving large document corpora where the inference engine instance may not have sufficient capacity to host the entire document feature corpus locally.

The content understanding platform 140 processes new content uploads 160 and generates embedding vectors 158 that represent content items in a dense vector space suitable for similarity computations. The content understanding platform 140 interfaces with the inference services 132 through vision/text model requests and results 164 to process content through computer vision and natural language understanding models. The generated embedding vectors 158 are stored and indexed to enable content-based retrieval and recommendation.

The application backend 142 interfaces with the inference services 132 and the retrieval services 138 to serve predictions to end-user applications. The application backend 142 issues ranking requests and results 166 to the inference services 132 and receives candidate retrieval results 162 from the retrieval services 138. The application backend 142 coordinates the flow of requests between retrieval and inference to deliver personalized content recommendations, advertisements, and other ML-driven experiences to platform users.

The ML monitoring system 144 provides comprehensive observability into all aspects of the machine learning pipeline, from feature generation through model inference. The ML monitoring system 144 receives feature and prediction logging 170 from the inference services 132 and tracks various statistical measures of predictions, including mean, maximum, and percentile values. The ML monitoring system 144 monitors statistics from prediction-time features for active models, including missing ratio, zero ratio, mean, maximum, minimum, empty list ratio, quantiles for dense numerical features, and list sizes for sparse identifier features. Additionally, the ML monitoring system 144 monitors discrepancies between online and offline predictions and features to ensure consistency between model behavior during offline evaluation and online serving. Business event logging 168 captures operational metrics across the system to enable performance tracking and cost optimization. The feature hydration process 148 ensures that features are properly retrieved and associated with inference requests throughout the system. Online features 156 flow from the distributed key-value store 136 to the inference services 132 to support real-time prediction serving.

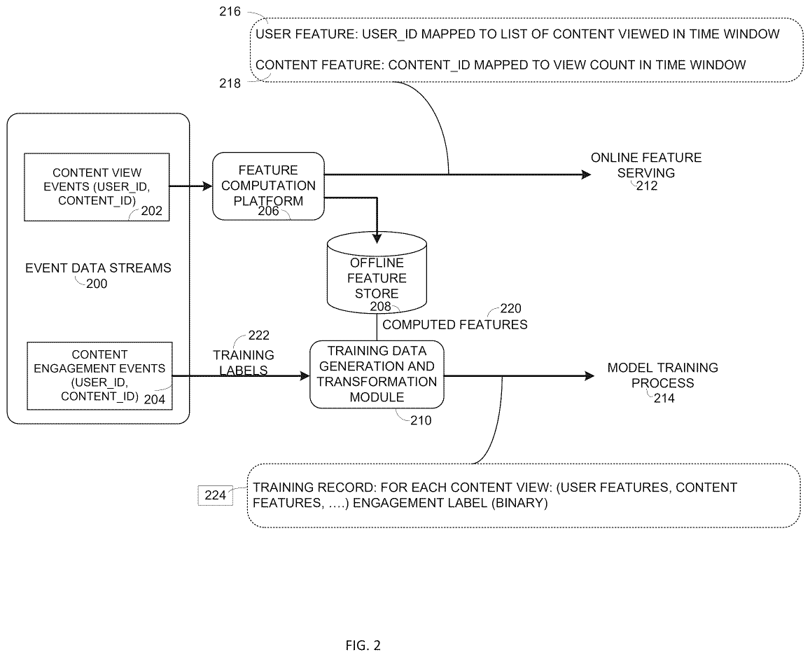

FIG. 2 is a diagram depicting a feature generation and training data preparation workflow for content recommendation use cases, according to some embodiments. As illustrated in FIG. 2, the machine learning platform implements a feature generation and training data preparation system that processes event data streams 200 to generate computed features 220 and training records for model training. The workflow illustrates the data flow from raw event capture through feature computation, offline storage, online serving, and ultimately to the model training process 214.

In accordance with some embodiments, the system receives event data streams 200 comprising user interaction events with content items. The event data streams 200 include content view events 202 that capture instances where a user identified by a user_id views a content item identified by a content_id. The event data streams 200 further include content engagement events 204 that capture instances where a user identified by a user_id engages with a content item identified by a content_id, such as through liking, sharing, commenting, or other engagement actions. These event data streams 200 provide the raw behavioral signals from which machine learning features are derived.

The feature computation platform 206 processes the event data streams 200 to generate computed features 220 by aggregating events over sliding time windows and grouping by entity keys. The feature computation platform 206 may be implemented using distributed processing frameworks capable of handling high-volume event streams at scale. As illustrated by the user feature example 216, a user feature may be defined as a mapping from a user_id to a list of content viewed within a specified time window, such as the last 24 hours. This user feature captures the recent viewing history for each user and enables personalization based on demonstrated content preferences. As illustrated by the content feature example 218, a content feature may be defined as a mapping from a content_id to a view count within a specified time window, such as the last 24 hours. This content feature captures the recent popularity of each content item and enables ranking based on content engagement trends.

The computed features 220 generated by the feature computation platform 206 are stored in an offline feature store 208 for training purposes. The offline feature store 208 may comprise data lake tables or other columnar storage formats optimized for batch access patterns required during training data generation. Simultaneously, the computed features 220 are disseminated to online feature serving 212 infrastructure to support real-time inference. The online feature serving 212 infrastructure enables the inference services to retrieve current feature values with low latency during prediction requests. This dual-path architecture ensures that features used during model training are consistent with features served during online inference, while allowing each storage system to be optimized for its respective access patterns.

In accordance with some embodiments, the training data generation and transformation module 210 assembles training records by combining the computed features 220 with training labels 222. Each training record is created by pairing a raw event containing a label with the corresponding aggregated features retrieved from the offline feature store 208. As illustrated by the training record format 224, for each content view event, a training record comprises user features, content features, and potentially additional contextual features, mapped to an engagement label that indicates whether the user engaged with the content item. The engagement label may be a binary indicator representing whether a positive engagement action occurred, or may comprise multi-class or continuous values representing different types or degrees of engagement.

The training data generation and transformation module 210 applies various transformations to the assembled training records before supplying them to the model training process 214. These transformations include, but are not limited to, standardization to normalize feature distributions, range-compression to bound feature values within specified ranges, and indexing to convert categorical features into numerical representations suitable for neural network consumption. In some embodiments, this process is implemented as a multi-step data pipeline executed using a combination of distributed processing frameworks. The output of this operation comprises a set of record files in a format suitable for consumption by the model training process 214, which utilizes the training records to learn model parameters that predict user engagement with content items.

The workflow illustrated in FIG. 2 supports the continuous generation of fresh training data as new events are recorded in the event data streams 200. The feature computation platform 206 processes incremental event data to update the computed features 220 in both the offline feature store 208 and the online feature serving 212 infrastructure. The training data generation and transformation module 210 can generate incremental training datasets that incorporate the latest user behavior, enabling automated incremental model training that maintains prediction accuracy as user preferences and content characteristics evolve over time.

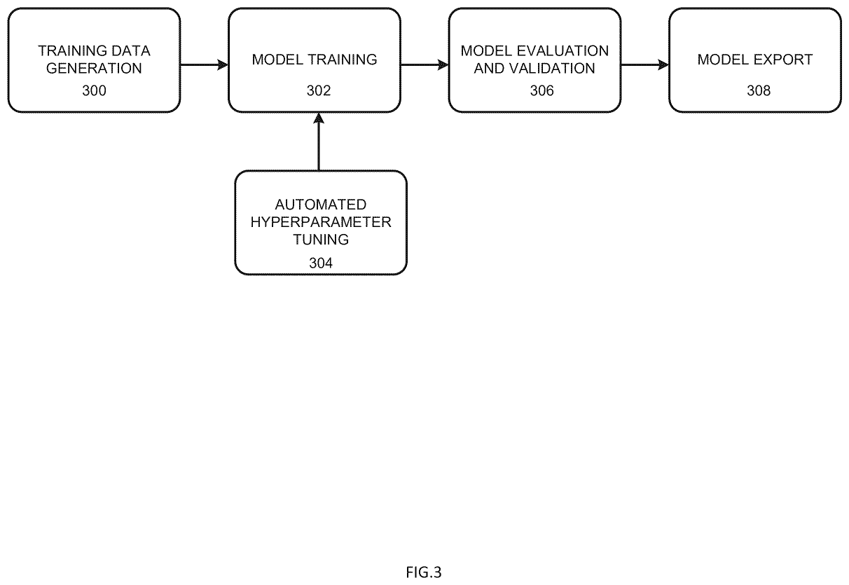

FIG. 3 is a flowchart illustrating steps of a model training pipeline including training data generation 300, model training 302, model evaluation and validation 306, and model export 308 phases, consistent with some embodiments. In some embodiments, as shown in FIG. 3, the model training process comprises a sequence of primary tasks that transform raw data into production-ready machine learning models. The pipeline begins with training data generation 300, proceeds through model training 302 with automated hyperparameter tuning 304, continues to model evaluation and validation 306, and concludes with model export 308 to prepare trained models for deployment to inference services.

The training data generation 300 phase assembles training records by combining computed features with training labels, as described with reference to FIG. 2. During this phase, raw events containing engagement labels are paired with aggregated user features and content features retrieved from the offline feature store. The training data undergoes various transformations including standardization, range-compression, and indexing before being output in a format suitable for consumption by the subsequent model training 302 phase. In some embodiments, the training data generation 300 phase is implemented as a multi-step data pipeline executed using distributed processing frameworks capable of handling petabyte-scale datasets.

The model training 302 phase executes as a Python application on specialized hardware including graphics processing units (GPUs) and tensor processing units (TPUs). To enhance development efficiency, particularly for ranking and recommendation applications, the system implements a three-layer architecture comprising: (1) a core ML frameworks layer, (2) a model implementation code layer, and (3) a training configuration layer, as described with reference to FIG. 1.

The core ML frameworks layer provides an internal library that encapsulates machine learning frameworks, standardizing modeling techniques and components for recommendation use cases. These standardized components include deep cross networks that efficiently model feature interactions, transformer architectures that capture sequential patterns in user behavior, and embedding layers that represent high-cardinality categorical features in dense vector spaces. This standardization enables efficient experimentation with various feature implementations and promotes code reuse across different ML applications and teams.

Engineers express models by authoring code in the model implementation code layer, leveraging the abstractions and components provided by the core ML frameworks layer. The training configuration layer comprises configuration files that specify execution parameters including hardware type, input and output data locations, batch size, learning rate schedules, and other runtime options that determine training behavior. This layered architecture facilitates rapid experimentation by enabling engineers to modify job configurations without changing model code, supporting thousands of model experiments per month.

The model training 302 phase integrates with automated hyperparameter tuning 304 to optimize model performance without requiring extensive manual parameter search. The automated hyperparameter tuning 304 employs Bayesian optimization techniques that suggest improved parameter values based on observed model performance metrics from previous training runs. Bayesian optimization builds a probabilistic model of the objective function and uses acquisition functions to determine which parameter configurations to evaluate next, efficiently exploring the parameter space while exploiting promising regions. Parameters subject to optimization include learning rate, batch size, regularization strength, dropout rates, and model architecture parameters such as layer dimensions, number of attention heads, and embedding sizes. The automated hyperparameter tuning 304 significantly reduces the manual effort required for parameter tuning while discovering configurations that improve model accuracy and generalization.

The model evaluation and validation 306 phase assesses the quality of trained models by computing performance metrics on held-out validation datasets. During this phase, the system generates model metrics including accuracy, precision, recall, area under the receiver operating characteristic curve (AUC-ROC), and application-specific metrics such as normalized discounted cumulative gain (NDCG) for ranking models. The evaluation results are uploaded to visualization tools for analysis and stored in a database accessible through the platform user interface. The model evaluation and validation 306 phase may include automated validation checks that compare model performance against baseline thresholds and previous model versions to ensure that only models meeting quality criteria proceed to the export phase.

The model export 308 phase takes the trained model and prepares it for deployment to inference services. During this phase, the system creates hardware-optimized model versions targeting different hardware configurations used in production inference. For models destined for inference on GPUs, the model export 308 phase examines the compute graph and determines which operations should be performed on GPUs—such as dense matrix multiplications that benefit from parallel execution—and which operations should be performed on CPUs, such as feature parsing and embedding lookups that are memory-bound rather than compute-bound. This optimization is crucial for reducing the serving costs of ranking and recommendation models, because these models exhibit a distinct pattern of dense computation that is compute-bound, along with large embedding lookup tables that are memory-size-bound. The model export 308 phase outputs trained model artifacts in serialized formats suitable for loading by inference engine instances.

The pipeline illustrated in FIG. 3 supports automated incremental training to maintain prediction accuracy as new events are recorded and user behavior patterns evolve. The workflow orchestration module schedules incremental execution of the training data generation 300 phase to append, join, and transform new training data. Incremental model training 302 jobs are automatically scheduled, and after passing through the model evaluation and validation 306 phase and the model export 308 phase, models are automatically deployed to production inference services. The ML monitoring system provides continuous monitoring to ensure the quality of incrementally trained models in production environments.

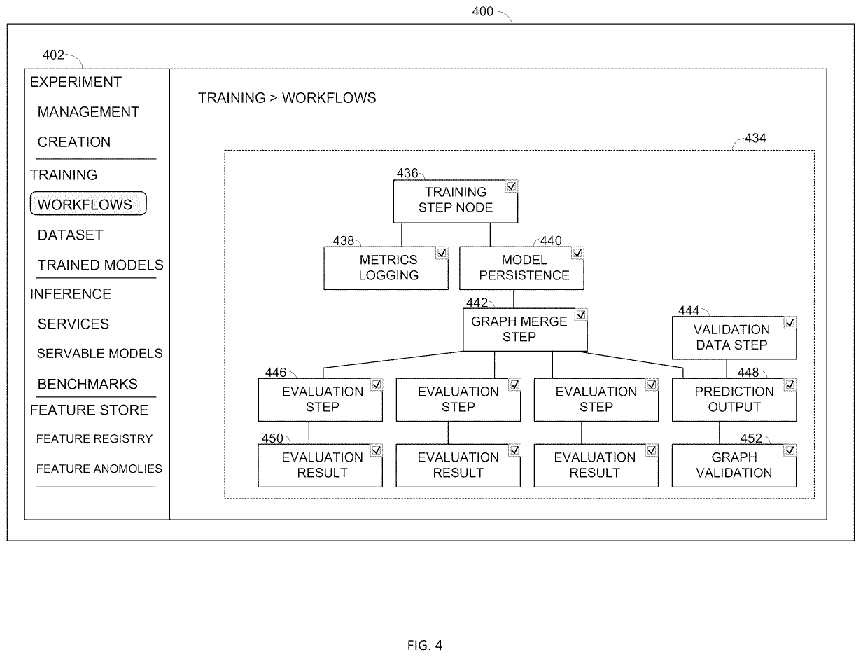

FIG. 4 is a user interface screenshot showing a training workflow visualization 434 with multiple processing stages and dependencies, according to some embodiments. As illustrated in FIG. 4, the platform user interface 400 provides a comprehensive view for managing and monitoring machine learning workflows throughout the development lifecycle. The platform user interface 400 includes a navigation panel on the left side that organizes platform functionality into logical sections including Experiment (with Management and Creation subsections), Training (with Workflows, Dataset, and Trained Models subsections), Inference (with Services, Servable Models, and Benchmarks subsections), and Feature Store (with Feature Registry and Feature Anomalies subsections). This hierarchical organization enables ML engineers to efficiently navigate between different aspects of the ML development lifecycle from a single unified interface.

The main content area of the platform user interface 400 displays a workflow view 402 that visualizes a training workflow as a directed acyclic graph (DAG). The workflow visualization 434 represents the sequence of processing stages and their dependencies, enabling engineers to understand the data flow and execution order of pipeline tasks. Each node in the workflow visualization 434 represents a distinct processing stage, and the directed edges between nodes indicate data dependencies that determine execution order. This visual representation enables engineers to quickly identify the structure of complex training pipelines and monitor the progress of individual stages during execution.

As shown in FIG. 4, the workflow visualization 434 begins with a training step node 436 that initiates the model training process. The training step node 436 represents the execution of the model training phase where the machine learning model learns parameters from the training data using the specified hardware accelerators and training configuration. Following the training step node 436, the workflow branches to a metrics logging step 438 that captures training metrics and uploads them to visualization tools for analysis. The metrics logging step 438 enables engineers to monitor training progress, visualize loss curves, and analyze convergence behavior through integrated visualization dashboards.

The workflow visualization 434 further includes a model persistence step 440 that saves the trained model to persistent storage for subsequent processing. The model persistence step 440 ensures that trained model weights and architecture definitions are durably stored and can be retrieved for evaluation, export, or deployment. A graph merge step 442 combines model components or sub-graphs into a unified model representation suitable for inference optimization. The graph merge step 442 may consolidate separately trained model components, such as embedding tables and neural network layers, into a single compute graph that can be analyzed and optimized as a unit.

The workflow visualization 434 includes a validation data step 444 that prepares held-out validation datasets for model evaluation. The validation data step 444 retrieves and preprocesses evaluation data that was not used during training, ensuring that model performance metrics reflect generalization capability rather than memorization of training examples. Multiple evaluation steps 446 execute in parallel to assess model quality across different metrics, datasets, or evaluation configurations. The parallel execution of evaluation steps 446 enables comprehensive model assessment while minimizing overall pipeline execution time.

The evaluation steps 446 feed into a prediction output step 448 that generates model predictions on the validation datasets. The prediction output step 448 applies the trained model to produce predicted scores or classifications that are compared against ground truth labels to compute performance metrics. Multiple evaluation result steps 450 collect and aggregate the outputs from the evaluation steps 446 and the prediction output step 448, computing final performance metrics and generating evaluation reports.

The workflow visualization 434 concludes with a graph validation step 452 that performs final validation checks on the merged and optimized model graph. The graph validation step 452 verifies that the model graph is well-formed, that all operations are compatible with target inference hardware, and that the model meets quality thresholds required for production deployment. Upon successful completion of the graph validation step 452, the model is ready for export and deployment to inference services.

The workflow visualization 434 enables engineers to monitor pipeline execution in real-time, with visual indicators showing the status of each processing stage. Completed stages may be displayed with success indicators, currently executing stages may be highlighted, and failed stages may be marked with error indicators along with diagnostic information. This visibility enables engineers to quickly identify and diagnose pipeline failures, reducing the time required to iterate on model development. The platform user interface 400 further enables engineers to drill down into individual stages to view detailed logs, metrics, and configuration parameters.

The system provides automated incremental training to maintain prediction accuracy as new data becomes available. The workflow orchestration module handles incremental data processing including appending, joining, and transforming new training data. Incremental training jobs are automatically scheduled through the workflow visualization 434, and after passing through the evaluation steps 446 and graph validation step 452, models are deployed to production with continuous monitoring by the ML monitoring system.

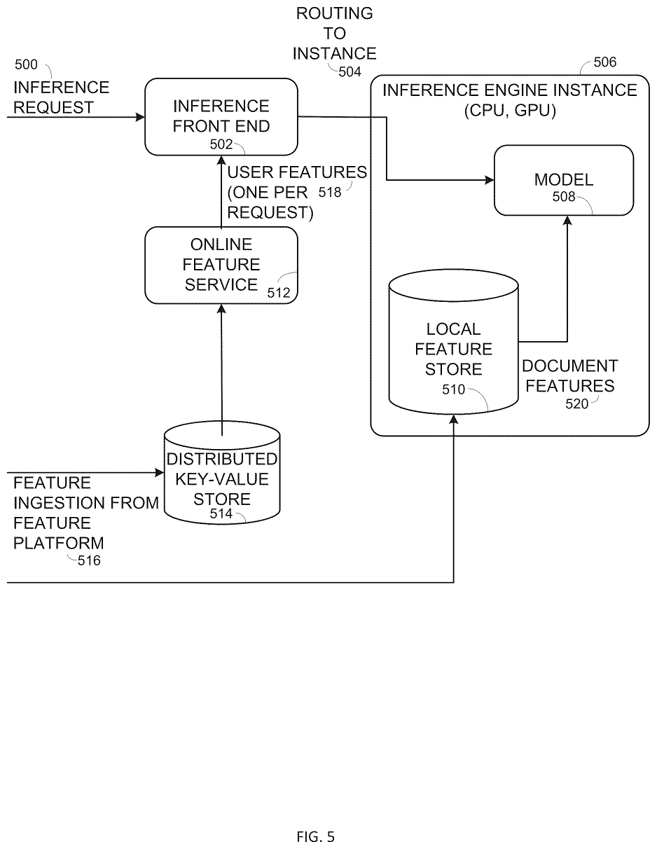

FIG. 5 is a diagram illustrating an inference service architecture with feature stores and model serving components, consistent with some embodiments. As shown in FIG. 5, the inference service architecture implements a two-part feature store design that optimizes high-fanout ranking operations by separating user feature retrieval from document feature hydration, thereby substantially reducing network calls, latency, and operational costs compared to conventional architectures that retrieve all features from centralized stores.

The inference service architecture receives an inference request 500 comprising a user identifier and a plurality of candidate content identifiers. The inference request 500 specifies a ranking operation to score each of the plurality of candidate content identifiers relative to a user context associated with the user identifier. In ranking and recommendation applications, a typical inference request 500 may include hundreds or thousands of candidate content identifiers that must be scored against the user context, creating a high-fanout scenario where efficient feature retrieval is critical to meeting latency requirements and controlling operational costs.

The inference front end 502 receives the inference request 500 and coordinates the retrieval of user features and the routing of requests to inference engine instances. The inference front end 502 serves as the entry point for all inference traffic and implements request processing logic including authentication, validation, and load balancing. Upon receiving an inference request 500, the inference front end 502 initiates retrieval of user features 518 from the distributed key-value store 514.

The distributed key-value store 514 serves as a centralized feature store for user features and is communicatively coupled to the feature computation platform through feature ingestion from feature platform 516. The feature ingestion from feature platform 516 represents the data flow through which aggregated user features computed by the feature computation platform are disseminated to the distributed key-value store 514 for online serving. The distributed key-value store 514 is optimized for low-latency key-based lookups and maintains current feature values that reflect recent user behavior captured in event data streams.

The online feature service 512 provides an interface for retrieving user features 518 from the distributed key-value store 514. For each inference request 500, the system performs a single user feature lookup to retrieve the set of user features 518 associated with the user identifier. The user features 518 may include aggregated behavioral features such as recently viewed content, engagement history, and preference indicators computed over sliding time windows. Because the inference request 500 pertains to a single user context, only one user feature retrieval operation is required regardless of the number of candidate content identifiers to be scored.

Following retrieval of the user features 518, the inference front end 502 performs routing to instance 504 to select an appropriate inference engine instance 506 from a plurality of available instances. The routing to instance 504 may be based on factors including load balancing, model availability, and hardware capabilities. The inference front end 502 transmits the inference request 500 and the retrieved user features 518 to the selected inference engine instance 506.

The inference engine instance 506 comprises specialized hardware including CPUs and GPUs configured to execute machine learning models efficiently. The inference engine instance 506 loads a model 508 that has been trained and exported through the model training pipeline described with reference to FIGS. 3 and 4. The model 508 may be optimized for the specific hardware configuration of the inference engine instance 506, with operations placed on GPUs or CPUs based on their computational characteristics as determined during the model export phase.

In accordance with some embodiments, the inference engine instance 506 hydrates document features 520 for each of the plurality of candidate content identifiers by accessing a local feature store 510 co-located with the inference engine instance 506. The local feature store 510 stores document features for a corpus of content items and is physically located on the same machine or within the same memory space as the inference engine instance 506. This co-location enables the hydrating of document features 520 to be performed without issuing network calls to the distributed key-value store 514 for document feature retrieval.

The local feature store 510 architecture provides significant technical advantages for high-fanout ranking scenarios. In conventional architectures, retrieving document features for hundreds or thousands of candidate content identifiers would require a corresponding number of network calls to a centralized feature store, resulting in aggregate latency that dominates request processing time and network bandwidth costs that scale linearly with prediction volume. By co-locating the local feature store 510 with the inference engine instance 506, the system eliminates these network calls entirely for document feature retrieval. The document features 520 are accessed through local memory operations that complete in microseconds rather than the milliseconds required for network round trips. This optimization enables the system to achieve substantially lower latency and reduced dataplane costs compared to conventional approaches.

The inference engine instance 506 executes the model 508 to generate relevance scores for each of the plurality of candidate content identifiers based on the user features 518 and the corresponding document features 520. The model 508 processes the combined feature vectors through neural network layers to produce predicted scores indicating the relevance or expected engagement of each content item for the specified user. The inference engine instance 506 returns the relevance scores in response to the inference request 500, enabling downstream application logic to select and rank content items for presentation to the user.

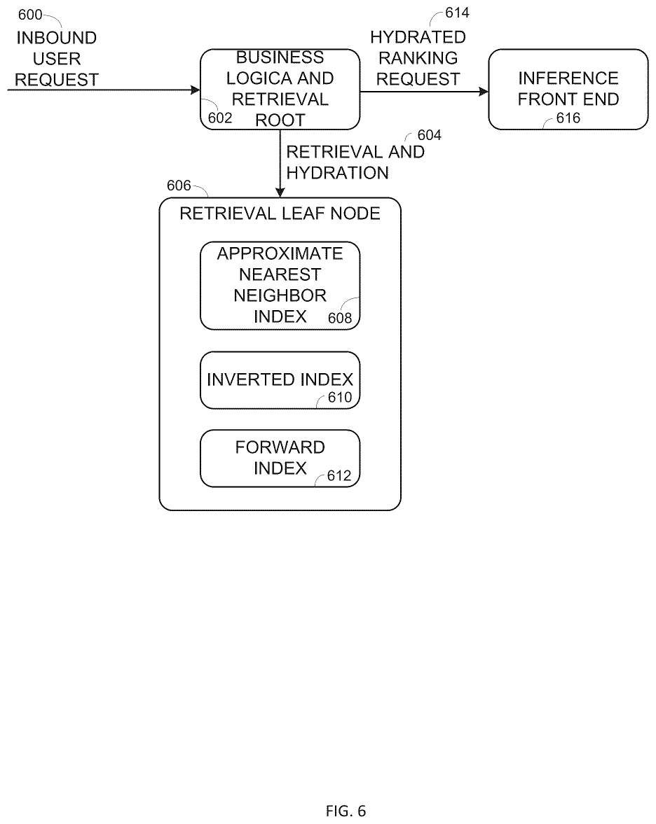

This two-part feature store architecture requires the inference engine instance 506 to have sufficient memory capacity to host the complete document feature corpus in the local feature store 510. For use cases where the document corpus is too large to fit in instance memory, an alternative architecture utilizing retrieval services with upstream feature hydration may be employed, as described with reference to FIG. 6. The choice between these architectural approaches depends on the size of the document corpus, the memory capacity of available inference hardware, and the latency and cost requirements of the specific application.

FIG. 6 is a diagram showing a retrieval system architecture for processing user requests through business logic, retrieval, and inference stages, according to some embodiments. As described with reference to FIG. 5, the two-part feature store architecture requires the inference engine instance 506 to have sufficient memory capacity to host the complete document feature corpus in the local feature store 510. For use cases where the document corpus exceeds available instance memory, the system implements a second strategy in which document feature hydration is pushed upstream through a retrieval service architecture. As illustrated in FIG. 6, this retrieval service architecture enables efficient document retrieval and feature hydration for large-scale corpora containing millions of documents.

The retrieval system architecture receives an inbound user request 600 that initiates the retrieval and ranking process. The inbound user request 600 may originate from an application backend and specifies parameters for content retrieval, such as a user identifier, query terms, contextual signals, and retrieval constraints. The inbound user request 600 is processed by a business logic and retrieval root 602 component that serves as the coordination layer for the distributed retrieval system.

The business logic and retrieval root 602 implements application-specific logic for interpreting the inbound user request 600 and formulating retrieval queries. The business logic and retrieval root 602 may apply business rules, filtering criteria, and personalization logic to determine which documents are eligible for retrieval and ranking. The business logic and retrieval root 602 coordinates with multiple retrieval leaf nodes 606 distributed across the retrieval infrastructure to execute the retrieval queries in parallel.

Each retrieval leaf node 606 contains an integrated suite of indexing components that enable efficient document retrieval through multiple access patterns. The retrieval leaf node 606 includes an approximate nearest neighbor index 608 that supports similarity-based retrieval using dense vector representations. The approximate nearest neighbor index 608 enables the system to identify documents whose embedding vectors are most similar to a query vector, supporting semantic retrieval based on learned representations from the content understanding platform. The approximate nearest neighbor index 608 may be implemented using algorithms such as hierarchical navigable small world graphs or locality-sensitive hashing that provide sublinear query complexity for high-dimensional vector spaces.

The retrieval leaf node 606 further includes an inverted index 610 that supports term-based retrieval using sparse representations. The inverted index 610 maps terms, tokens, or categorical attributes to the documents containing those terms, enabling efficient Boolean queries and keyword-based retrieval. The inverted index 610 supports complex query expressions including conjunctions, disjunctions, and phrase matching, and may incorporate relevance scoring based on term frequency and document frequency statistics.

The retrieval leaf node 606 additionally includes a forward index 612 that stores document attributes and features indexed by document identifier. The forward index 612 enables efficient lookup of document metadata and feature values once candidate documents have been identified through the approximate nearest neighbor index 608 or the inverted index 610. Critically, the forward index 612 stores the document features required for model inference, enabling the retrieval and hydration 604 process to return documents along with their associated features in a single query operation.

The retrieval and hydration 604 process represents the data flow through which the business logic and retrieval root 602 queries the retrieval leaf nodes 606 and receives candidate documents with their associated features. The distributed architecture of multiple retrieval leaf nodes 606 enables the system to partition large document corpora across nodes, with each node responsible for a subset of the total corpus. The business logic and retrieval root 602 fans out queries to the relevant retrieval leaf nodes 606 and aggregates the results to produce a unified set of candidate documents. This distributed retrieval system enables flexible, single-pass retrieval and feature hydration queries that can return relevant documents along with their associated features, eliminating the need for separate feature lookup operations.

The retrieval and hydration 604 process produces a hydrated ranking request 614 that includes the candidate documents, their associated features, and the user context required for ranking. The hydrated ranking request 614 contains all information necessary for the inference services 616 to execute model inference without additional feature retrieval operations. The hydrated ranking request 614 is forwarded to the inference services 616 for final processing, where trained machine learning models generate relevance scores for each candidate document.

The inference services 616 receive the hydrated ranking request 614 and execute ranking models to score the candidate documents. Because the document features have already been hydrated during the retrieval and hydration 604 process, the inference services 616 do not need to access the local feature store or the distributed key-value store for document feature retrieval. The inference services 616 retrieve user features from the distributed key-value store 514 as described with reference to FIG. 5, combine them with the pre-hydrated document features, and execute the model to generate relevance scores. This architecture is particularly advantageous for use cases involving very large document corpora that exceed the memory capacity of individual inference engine instances.

The system employs sophisticated optimization techniques to enhance inference engine performance and reduce operational costs. As illustrated in FIG. 5, the system utilizes a shared-nothing architecture within the inference engine instance 506, implementing precise thread management for the machine learning runtime environment. This architecture maximizes CPU core utilization while minimizing lock contention, with the inference engine implementation specifically tailored for the target hardware platform configuration. Each inference engine instance 506 operates independently without shared state, enabling horizontal scaling by adding additional instances to handle increased traffic.

The model export 308 phase, depicted in FIG. 3, implements hardware-specific model optimization by generating multiple versions of each model, each specifically optimized for different hardware architectures. This approach ensures optimal performance across diverse computing platforms including CPU-only instances, GPU-accelerated instances, and specialized inference accelerators. The system further enhances performance through dynamic model deployment optimization, allowing each inference engine instance 506 to host multiple models 508 simultaneously, as shown in FIG. 5. Model co-location decisions are strategically determined based on performance characteristics, resource utilization patterns, and traffic volumes, with containerized inference engine fleets providing independent scalability for different use cases.

The system incorporates advanced request optimization through the inference front end 502 service, as illustrated in FIG. 5. The inference front end 502 enables multiplexing of multiple model requests within a single remote procedure call, performing dynamic request unbundling, batching, and routing to instance 504 to optimize throughput and minimize latency. When multiple sub-requests for different models arrive, the inference front end 502 groups sub-requests destined for the same inference engine instance 506 into batches, reducing network overhead and improving hardware utilization. The data plane implementation minimizes overhead through optimized inference APIs that enable ML features to be transmitted as raw bytes between components, with feature deserialization occurring only within the inference engine instance 506. This optimization includes custom protocol buffer implementations that substantially reduce both latency and data transfer costs, achieving significant improvements in dataplane efficiency compared to conventional serialization approaches.

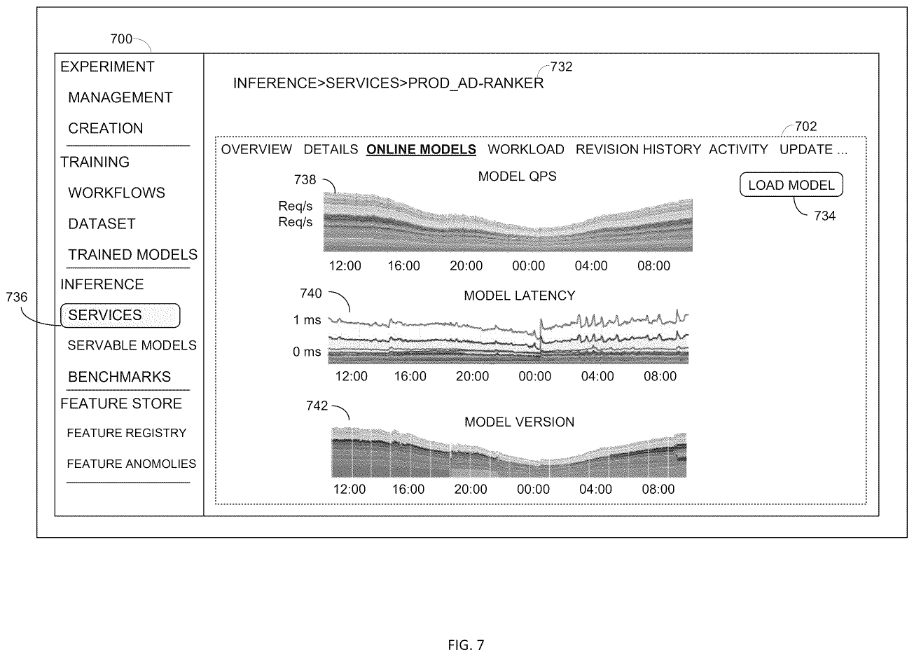

FIG. 7 is a user interface screenshot depicting a model monitoring dashboard showing performance metrics and deployment status for production inference services, consistent with some embodiments. As illustrated in FIG. 7, the platform user interface 700 provides comprehensive visibility into the operational status and performance characteristics of deployed machine learning models, enabling ML engineers to monitor model health, track throughput and latency metrics, and manage model versions in production environments.

The platform user interface 700 includes a navigation panel on the left side that organizes platform functionality into logical sections, consistent with the navigation structure described with reference to FIG. 4. The navigation panel includes sections for Experiment (with Management and Creation subsections), Training (with Workflows, Dataset, and Trained Models subsections), Inference (with Services, Servable Models, and Benchmarks subsections), and Feature Store (with Feature Registry and Feature Anomalies subsections). The Inference section and Services subsection are highlighted in FIG. 7, indicating that the user has navigated to the inference services monitoring view. This hierarchical navigation enables ML engineers to efficiently transition between model development activities and production monitoring from a single unified interface.

The main content area of the platform user interface 700 displays a workflow view 702 that provides detailed monitoring information for a selected production service. A production service instance 732 is displayed at the top of the workflow view 702, identifying the specific inference service being monitored. The production service instance 732 represents a deployed inference service that hosts one or more trained machine learning models and processes inference requests from application backends. In the illustrated example, the production service instance 732 corresponds to a content ranking service that scores candidate content items for relevance to user contexts.

The workflow view 702 includes a load model control 734 that enables ML engineers to deploy new model versions to the production service instance 732. The load model control 734 initiates a deployment workflow that loads a trained model artifact into the inference engine instances associated with the production service instance 732. The deployment process may include validation checks to ensure model compatibility with the serving infrastructure, gradual traffic shifting to minimize risk during model updates, and automated rollback capabilities if performance degradation is detected.

The workflow view 702 includes a service detail tabs section 736 that provides multiple views into different aspects of the production service instance 732. The service detail tabs 736 include tabs for Overview, Details, Online Models, Workload, Revision History, Activity, and Update Queue, among others. These tabs enable ML engineers to access comprehensive information about the service configuration, currently deployed models, historical changes, and pending updates. The Online Models tab, which is selected in the illustrated example, displays performance metrics for the models currently serving production traffic.

The workflow view 702 displays a model queries per second chart 738 that visualizes the throughput of the production service instance 732 over time. The model queries per second chart 738 shows the rate at which inference requests are processed, measured in requests per second (Req/s). The chart displays multiple time series representing different model versions or model endpoints, enabling engineers to compare throughput across models and identify traffic patterns. The horizontal axis represents time, spanning approximately 24 hours in the illustrated example, while the vertical axis represents the request rate. The model queries per second chart 738 enables engineers to monitor traffic volumes, identify peak usage periods, and ensure that the inference infrastructure has sufficient capacity to handle demand.

The workflow view 702 displays a model latency chart 740 that visualizes the response time of the production service instance 732 over time. The model latency chart 740 shows inference latency measured in milliseconds (ms), with the illustrated example showing latency values in the range of approximately 0 ms to 1 ms. The chart displays latency percentiles or aggregated latency statistics that enable engineers to understand the distribution of response times and identify latency anomalies. Low and consistent latency is critical for ranking and recommendation applications where inference results must be returned within strict time budgets to maintain user experience quality. The model latency chart 740 enables engineers to detect latency degradation that may indicate resource contention, model performance issues, or infrastructure problems.

The workflow view 702 displays a model version chart 742 that visualizes which model versions are serving production traffic over time. The model version chart 742 uses a stacked or banded representation to show the distribution of traffic across different model versions, enabling engineers to track model rollouts, identify version transitions, and monitor the deployment status of new models. The model version chart 742 is particularly valuable during incremental model updates, where new model versions are gradually rolled out to increasing percentages of traffic while engineers monitor for performance regressions. The chart enables engineers to correlate changes in throughput or latency with specific model version deployments.

The monitoring capabilities illustrated in FIG. 7 support the operational requirements of high-scale production inference services that process billions of predictions per second across hundreds of millions of daily active users. The combination of throughput monitoring through the model queries per second chart 738, latency monitoring through the model latency chart 740, and version tracking through the model version chart 742 provides comprehensive visibility into inference service health. These monitoring capabilities integrate with the ML monitoring system described with reference to FIG. 1, which tracks feature and prediction logging 170, detects anomalies in features and predictions, and monitors discrepancies between online and offline model behavior.

The platform user interface 700 enables engineers to configure alerting thresholds based on the metrics displayed in the workflow view 702, triggering notifications when throughput drops below expected levels, latency exceeds acceptable thresholds, or model version deployments encounter issues. This proactive monitoring capability enables rapid detection and response to production issues, minimizing the impact of anomalies on user experience and business outcomes.

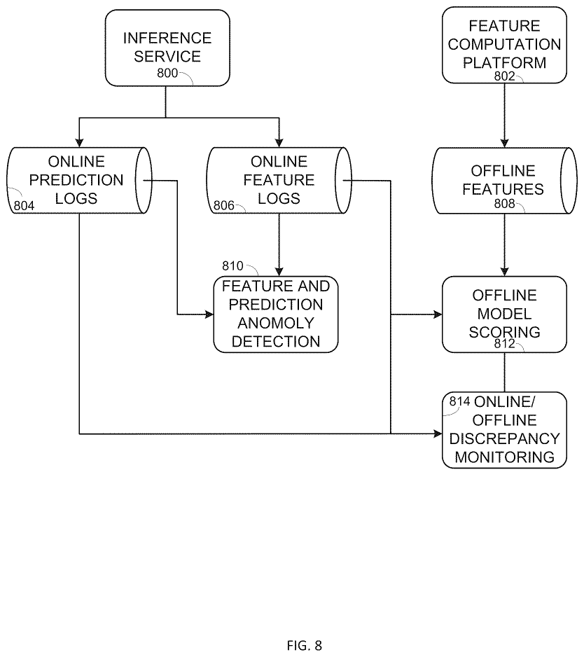

In particular embodiments, as illustrated in FIG. 8, the system implements a sophisticated monitoring architecture comprising multiple integrated components. The Inference Service generates two types of logs: Online Prediction Logs that capture model predictions and Online Feature Logs that record feature usage. These logs are processed by a Feature and Prediction Anomaly Detection system that continuously analyzes the data for potential issues.

The monitoring system further includes an Offline Model Rescoring component that evaluates model performance using offline data, and an Online/Offline Discrepancy Monitoring system that ensures consistency between online and offline predictions. The Robusta Feature Platform feeds Offline Features into this monitoring pipeline to enable comprehensive validation of the system's behavior.

The monitoring architecture enables automated detection of anomalies in both feature distributions and prediction patterns, allowing for proactive identification of potential issues before they impact system performance. The system maintains continuous validation of model performance through parallel offline rescoring processes while simultaneously tracking any discrepancies between online and offline behavior to ensure consistent and reliable operation.

Through this integrated monitoring approach, the system provides comprehensive observability into all aspects of the machine learning pipeline, from feature generation through model inference, enabling rapid detection and diagnosis of potential issues while maintaining high performance and reliability standards.

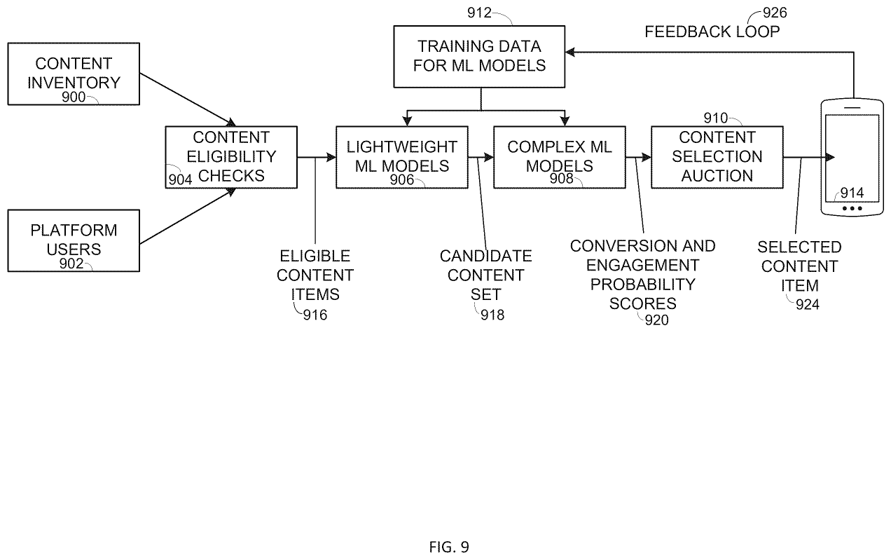

FIG. 9 is a diagram illustrating a content ranking workflow incorporating machine learning models, consistent with some embodiments. As illustrated in FIG. 9, the system implements a content ranking architecture designed to optimize content selection and delivery for platform users 902. While the workflow is described in the context of content ranking for advertisement delivery, the architecture is applicable to other content selection use cases including organic content recommendations, friend suggestions, and personalized notifications. The system comprises multiple integrated components that work together to select and serve relevant content while maintaining user privacy and security standards.

The system, as shown in FIG. 9, includes a content inventory 900 that stores the corpus of content items eligible for ranking and delivery. The content inventory 900 may contain millions of content items at any given time, each associated with metadata, targeting parameters, and content features computed by the feature computation platform. The content inventory 900 interfaces with platform users 902 data components to enable personalized content selection based on user preferences, behavioral history, and contextual signals.

The content inventory 900 and platform users 902 data feed into content eligibility checks 904 that apply filtering criteria to determine which content items are eligible for serving to particular users based on multiple parameters. The content eligibility checks 904 enforce targeting rules, privacy requirements, frequency caps, and business constraints that limit which content items may be shown to specific users in specific contexts. The content eligibility checks 904 produce eligible content items 916 that have passed all filtering criteria and are candidates for ranking.

In particular embodiments, the system implements a sophisticated two-stage machine learning pipeline for content processing, as shown in FIG. 9. The first stage employs lightweight ML models 906 specifically designed for high-throughput initial filtering of the eligible content items 916. The lightweight ML models 906 are optimized for computational efficiency and can rapidly score large volumes of content items using simplified feature sets and model architectures. The lightweight ML models 906 efficiently process the eligible content items 916 to generate a candidate content set 918 comprising a reduced number of content items that warrant more detailed evaluation. This initial filtering stage enables the system to efficiently narrow millions of eligible content items down to a manageable candidate set without incurring the computational cost of applying complex models to all items.

The second stage utilizes complex ML models 908 that conduct detailed analysis of the candidate content set 918 using sophisticated architectures to generate precise probability scores. The complex ML models 908 may employ deep neural networks with large embedding tables, attention mechanisms, and cross-feature interactions that capture nuanced relationships between user preferences and content characteristics. The complex ML models 908 generate conversion and engagement probability scores 920 that predict the likelihood of user engagement actions such as clicks, views, conversions, or other desired outcomes. The conversion and engagement probability scores 920 include metrics such as p(conversion) representing the probability that a user will complete a conversion action and p(engagement) representing the probability that a user will engage with the content item.

The system includes a content selection auction 910 that processes the conversion and engagement probability scores 920 from the complex ML models 908 along with additional auction parameters to select optimal content for delivery. The content selection auction 910 implements ranking logic that combines the probability scores with business objectives, bid values, and relevance factors to determine which content items should be presented to the user. The content selection auction 910 produces a selected content item 922 that represents the winning content determined through the auction process. The selected content item 922 is delivered to a client device display 914 for presentation to the user.

The system maintains a continuous feedback loop 924 where interaction data from served content is captured and processed into training data for ML models 912. As depicted in FIG. 9, the feedback loop 924 connects the client device display 914 back to the training data for ML models 912, capturing user interactions such as clicks, views, dismissals, conversions, and engagement actions. This feedback mechanism enables ongoing improvement of both the lightweight ML models 906 and the complex ML models 908 through continuous learning from actual user interactions and engagement patterns.

The training data for ML models 912 aggregates the feedback signals captured through the feedback loop 924 and processes them into training records suitable for model training. The training data for ML models 912 feeds into the training data generation and model training pipeline described with reference to FIGS. 2 and 3, where new model versions are trained using the latest interaction data. This automated model update process ensures the system continuously adapts to changing user preferences, content characteristics, and engagement patterns without requiring manual intervention.

The machine learning components illustrated in FIG. 9 address multiple technical challenges including complex model training and deployment optimization, real-time feature maintenance and serving, development efficiency improvements, data accuracy validation, automated model updates, and operational cost optimization. These challenges are managed through the system's integrated architecture that combines feature generation, model training, and inference services through a unified platform, as shown in FIG. 1, enabling efficient development and deployment of machine learning models at scale.

The system's architecture enables efficient scaling of content processing while maintaining high performance standards through its two-stage ML approach. The lightweight ML models 906 provide rapid initial filtering that reduces the candidate set to a manageable size, while the complex ML models 908 ensure precise scoring of the most promising candidates. This staged approach optimizes both computational resources and content relevance by applying the most expensive computations only to content items most likely to be relevant to the user. The architecture supports the processing of billions of content ranking requests per day while maintaining low latency and high prediction quality.

In some embodiments, the machine learning platform provides significant technical advantages through its comprehensive architecture and capabilities that represent clear improvements over conventional machine learning infrastructure. The system enables substantial increases in model complexity and scale compared to prior art solutions, with ranking models capable of handling exponentially larger parameter spaces and training data volumes. Where conventional systems struggle to process training datasets beyond terabyte scale, the disclosed platform efficiently handles petabyte-scale training data through its integrated feature computation platform 120 and training data generation module 118. The platform facilitates enhanced feature processing capabilities that allow for increased feature volume and prediction throughput, enabling organizations to incorporate richer feature sets that capture more nuanced patterns in user behavior and content characteristics than was possible with previous approaches.

The two-part feature store architecture described with reference to FIG. 5 provides substantial technical advantages over conventional feature serving approaches. In prior art systems, retrieving features for high-fanout ranking scenarios requires multiple network calls to centralized feature stores, with each candidate content item necessitating a separate feature lookup operation. This conventional architecture results in aggregate latency that scales linearly with the number of candidates and network bandwidth costs that dominate operational expenses. The disclosed system addresses these limitations through its innovative separation of user features into the distributed key-value store 514 and document features into the local feature store 510 co-located with the inference engine instance 506. By performing document feature hydration locally without issuing network calls to the distributed key-value store 514, the system achieves substantially lower latency and significantly reduced dataplane costs compared to conventional approaches. This architectural improvement enables the system to score larger candidate sets within fixed latency budgets, directly improving the precision and recall of ranking and recommendation applications.

The integrated end-to-end architecture of the disclosed platform eliminates the fragmentation and inefficiencies inherent in conventional machine learning infrastructure. Prior art solutions require organizations to assemble disparate components including separate big data processing frameworks for feature engineering, independent ML training frameworks for model development, standalone workflow orchestration tools for pipeline management, and distinct serving infrastructure for production inference. Each integration point between these components requires custom engineering effort, and product teams across an organization must independently develop and maintain these integrations, resulting in duplicated effort and inconsistent implementations. The disclosed platform addresses this limitation by providing a unified ML development experience through the platform user interface 100 that integrates big data technologies, ML frameworks, workflow engines, and cloud services into a centralized platform. This integration eliminates the duplicate effort that product teams previously needed to perform to integrate with internal technology stacks, enabling engineers to focus on model development and experimentation rather than infrastructure integration.

The platform provides specialized optimization for high-scale tasks like ranking and recommendation that exceed the design assumptions of readily available software and services. Conventional ML platforms are typically designed for general-purpose workloads and lack the specialized optimizations necessary for applications that must process billions of predictions per second while maintaining sub-millisecond latency. The disclosed system achieves these performance requirements through multiple optimization techniques implemented across the architecture. The inference front end 502 enables multiplexing of multiple model requests within a single remote procedure call, performing dynamic request unbundling, batching, and routing to instance 504 to optimize throughput and minimize latency. The data plane implementation minimizes overhead through optimized inference APIs that enable ML features to be transmitted as raw bytes between components, with feature deserialization occurring only within the inference engine instance 506. These optimizations, combined with custom protocol buffer implementations, result in substantially reduced latency and significantly lower dataplane costs compared to conventional serialization approaches.

The automated model lifecycle management capabilities of the disclosed platform represent a significant advancement over manual processes required by prior art systems. Conventional approaches require engineers to manually orchestrate the flow of data and artifacts between training data generation, model training, model evaluation, and model deployment stages, introducing delays in the model update cycle and increasing the risk of errors during deployment. The disclosed system automates this entire lifecycle through the workflow orchestration module 104 and deployment orchestration module 106. As illustrated in FIG. 3, the training pipeline comprising training data generation 300, model training 302 with automated hyperparameter tuning 304, model evaluation and validation 306, and model export 308 executes as an automated workflow that can be triggered on schedule or in response to new data availability. The automated hyperparameter tuning 304 employs Bayesian optimization techniques that suggest improved parameter values based on observed model performance metrics, reducing the manual effort required for parameter search while discovering configurations that improve model accuracy. This automation enables engineers to conduct thousands of model experiments per month, a scale of experimentation that would be impractical with conventional manual processes.

The comprehensive monitoring architecture illustrated in FIG. 8 provides observability and quality assurance capabilities that were not possible with previous systems. Conventional ML monitoring typically focuses on standard microservice metrics such as availability and throughput, lacking the specialized instrumentation necessary to detect subtle issues in ML-specific dimensions such as feature drift and prediction distribution shifts. The disclosed system addresses this gap through the feature and prediction anomaly detection 810 component that continuously analyzes online prediction logs 804 and online feature logs 806 to identify potential issues. The monitoring architecture further includes the offline model rescoring 812 component that evaluates model performance using offline data, and the online/offline discrepancy monitoring 814 system that ensures consistency between online and offline predictions. These capabilities enable proactive identification of potential issues before they significantly impact system performance or user experience, providing a level of ML-specific observability that distinguishes the disclosed platform from conventional solutions.

The retrieval service architecture described with reference to FIG. 6 provides technical advantages for use cases involving very large document corpora that exceed the memory capacity of individual inference engine instances. Conventional systems face a tradeoff between feature access latency and corpus size, either limiting the document corpus to what can fit in instance memory or accepting the latency penalty of centralized feature retrieval. The disclosed retrieval service architecture resolves this tradeoff through the distributed retrieval leaf nodes 606, each containing an integrated suite of indexing components including the approximate nearest neighbor index 608, inverted index 610, and forward index 612. This architecture enables flexible, single-pass retrieval and hydration queries that return relevant documents along with their associated features, eliminating the need for separate feature lookup operations while supporting corpora of arbitrary size through horizontal scaling of retrieval leaf nodes 606.

The content ranking workflow illustrated in FIG. 9 demonstrates the practical application of these technical advantages through a two-stage machine learning pipeline that optimizes both computational efficiency and ranking quality. The lightweight ML models 906 provide rapid initial filtering that reduces millions of eligible content items to a manageable candidate content set 918, while the complex ML models 908 ensure precise scoring of the most promising candidates through sophisticated architectures that generate accurate conversion and engagement probability scores 920. The continuous feedback loop 924 captures interaction data from served content and processes it into training data for ML models 912, enabling ongoing improvement through continuous learning from actual user interactions. This architecture enables the system to process billions of content ranking requests per day while maintaining low latency, high prediction quality, and efficient resource utilization, representing a significant improvement over conventional content ranking systems that lack the scale, sophistication, or automation capabilities of the disclosed platform.

The system implements universal understanding capabilities across multiple domains including user behavior, graph relationships, and content analysis through the content understanding platform 140 and its integration with the broader platform architecture. These capabilities are unified through the platform user interface 100 that enables leveraging data and insights across product surfaces to deliver improved model performance. The embedding vectors 158 generated by the content understanding platform 140 enable semantic similarity computations and content-based retrieval that complement collaborative filtering approaches, providing richer personalization than is possible with either approach alone. Through this integrated architecture, the disclosed platform enables organizations to deploy and manage machine learning workloads at scales previously unattainable with conventional solutions, transforming machine learning from a specialized capability requiring substantial custom engineering into a scalable, efficient, and reliable foundation for intelligent applications.

### SOFTWARE ARCHITECTURE

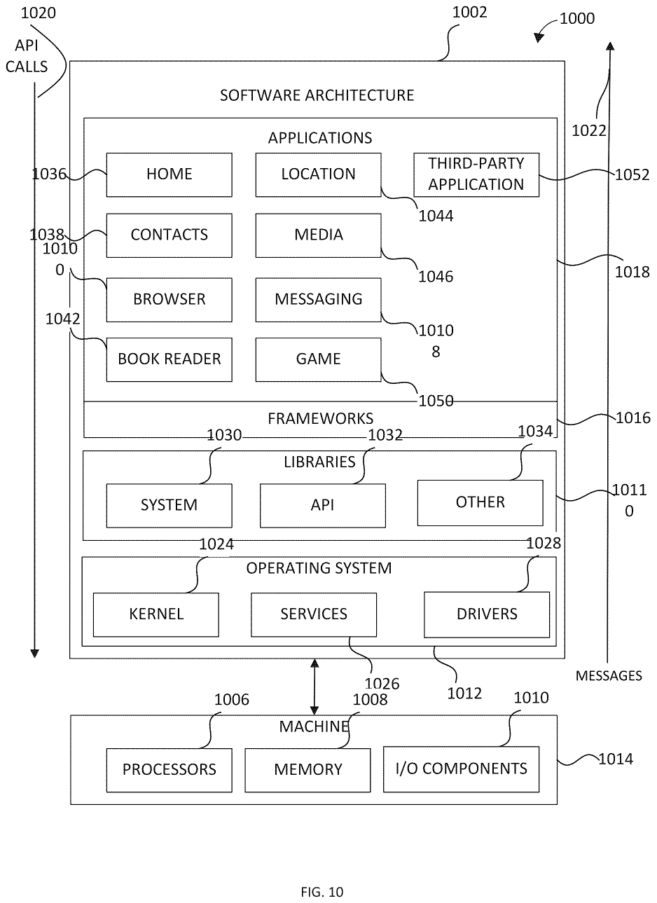

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematical functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

### MACHINE ARCHITECTURE

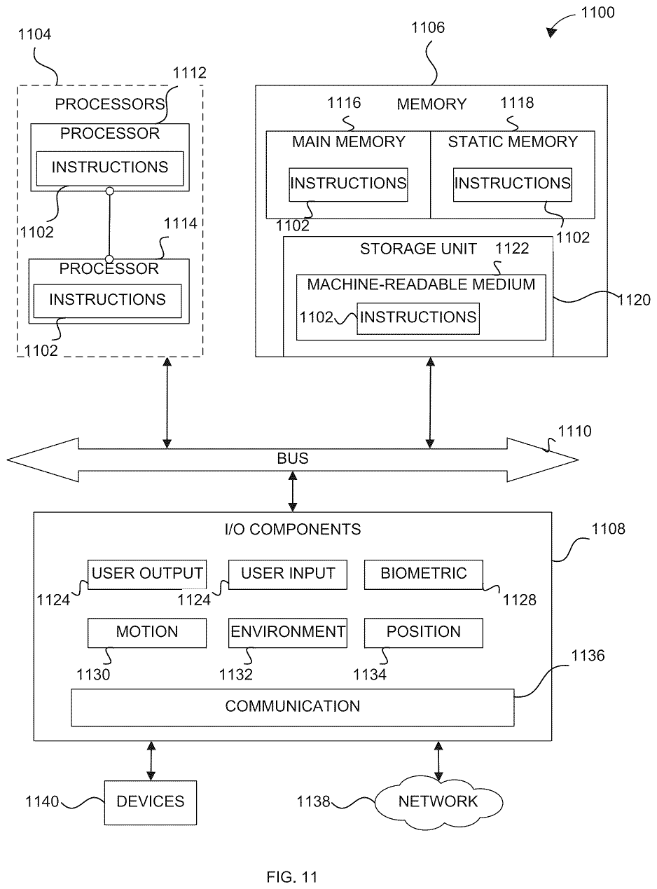

FIG. 11 is a diagrammatic representation of the machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise a user system or any one of multiple server devices forming part of a server system. In some examples, the machine 1100 may also comprise both client and server systems, with certain operations of a particular method or algorithm being performed on the server-side and with certain operations of the method or algorithm being performed on the client-side.

The machine 1100 may include processors 1104, memory 1106, and input/output I/O components 1108, which may be configured to communicate with each other via a bus 1110.

The processors 1104 may include one or more processors, such as a processor 1112 and a processor 1114, that execute the instructions 1102. The processors 1104 may comprise any number of processing elements that may or may not be co-located. In some embodiments, the processors 1104 may include graphics processing units (GPUs) or tensor processing units (TPUs) configured to accelerate machine learning model training and inference operations as described herein.

The memory 1106 includes a main memory 1116, a static memory 1118, and a storage unit 1120, all accessible to the processors 1104 via the bus 1110. The main memory 1116, the static memory 1118, and storage unit 1120 store the instructions 1102 embodying any one or more of the methodologies or functions described herein. The instructions 1102 may also reside, completely or partially, within the main memory 1116, within the static memory 1118, within a machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The I/O components 1108 may further include biometric components 1128, motion components 1130, environment components 1132, and position components 1134. The biometric components 1128 may include fingerprint sensors, facial recognition sensors, retinal scanners, voice recognition components, and other components for detecting biometric characteristics. The motion components 1130 include acceleration sensor components (e.g., accelerometer), gravitation sensor components, and rotation sensor components (e.g., gyroscope).

The environment components 1132 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment.

The position components 1134 include location sensor components (e.g., a Global Positioning System (GPS) receiver component), altitude sensor components (e.g., altimeters or barometers that detect air pressure from which altitude may be derived), orientation sensor components (e.g., magnetometers), and the like. The position components 1134 may be used to determine the geographic location or orientation of the machine 1100.

Communication may be implemented using a wide variety of technologies. The I/O components 1108 further include communication components 1136 operable to couple the machine 1100 to a network 1138 or devices 1140 via respective coupling or connections. For example, the communication components 1136 may include a network interface component or another suitable device to interface with the network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a USB).

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

### EXAMPLES

Example 1 is a method for serving machine learning inference requests in a distributed computing environment, the method comprising: receiving, at an inference front end of a machine learning platform, an inference request comprising a user identifier and a plurality of candidate content identifiers, the inference request specifying a ranking operation to score each of the plurality of candidate content identifiers relative to a user context associated with the user identifier; retrieving, from a distributed key-value store, a set of user features associated with the user identifier, the distributed key-value store communicatively coupled to a feature computation platform that generates aggregated features from event data streams; transmitting the inference request and the set of user features to an inference engine instance selected from a plurality of inference engine instances; hydrating, at the inference engine instance, a set of document features for each of the plurality of candidate content identifiers by accessing a local feature store co-located with the inference engine instance, the local feature store storing document features for a corpus of content items and the hydrating performed without issuing network calls to the distributed key-value store for document feature retrieval; executing, at the inference engine instance, a trained machine learning model to generate a relevance score for each of the plurality of candidate content identifiers based on the set of user features and the corresponding set of document features; and returning, from the inference engine instance, the relevance scores for the plurality of candidate content identifiers in response to the inference request.

In Example 2, the subject matter of Example 1 includes, wherein the feature computation platform generates the aggregated features by processing the event data streams over sliding time windows and grouping by entity keys, and wherein the aggregated features are stored in both an offline feature store for model training and the distributed key-value store for online inference serving.

In Example 3, the subject matter of Examples 1-2 includes, routing, by the inference front end, the inference request to the inference engine instance based on a model co-location configuration that specifies which trained machine learning models are loaded on each of the plurality of inference engine instances, wherein the inference engine instance hosts a plurality of trained machine learning models simultaneously.

In Example 4, the subject matter of Examples 1-3 includes, logging, by the inference engine instance, online prediction data comprising the relevance scores and associated feature values to an online prediction log store; and detecting, by a monitoring system, anomalies in the relevance scores or the associated feature values by comparing statistical measures of the online prediction data against expected distributions.

In Example 5, the subject matter of Example 4 includes, performing, by the monitoring system, offline model rescoring using offline features from an offline feature store to generate offline relevance scores; and identifying, by the monitoring system, discrepancies between the relevance scores generated during online inference and the offline relevance scores generated during the offline model rescoring.

In Example 6, the subject matter of Examples 1-5 includes, wherein the trained machine learning model is generated by a training pipeline comprising: generating training data by pairing raw events containing engagement labels with aggregated features retrieved from an offline feature store; training the machine learning model using the training data on hardware accelerators comprising at least one of graphics processing units or tensor processing units; evaluating the trained machine learning model to generate model performance metrics; and exporting the trained machine learning model by generating hardware-optimized model versions for deployment to the plurality of inference engine instances.

In Example 7, the subject matter of Example 6 includes, wherein the training pipeline further comprises: performing automated hyperparameter tuning using Bayesian optimization to identify improved parameter values based on observed model performance metrics, wherein the parameter values comprise at least one of learning rate, batch size, or layer dimensions.

In Example 8, the subject matter of Examples 1-7 includes, receiving, at the inference front end, a plurality of sub-requests for different trained machine learning models within a single remote procedure call; unbundling, by the inference front end, the plurality of sub-requests; batching, by the inference front end, sub-requests destined for a common inference engine instance; and routing the batched sub-requests to the common inference engine instance to reduce network overhead.

Example 9 is a system for serving machine learning inference requests in a distributed computing environment, the system comprising: one or more processors; and one or more memory storage devices storing instructions thereon, which, when executed by the one or more processors, cause the system to perform operations comprising: receiving, at an inference front end of a machine learning platform, an inference request comprising a user identifier and a plurality of candidate content identifiers, the inference request specifying a ranking operation to score each of the plurality of candidate content identifiers relative to a user context associated with the user identifier; retrieving, from a distributed key-value store, a set of user features associated with the user identifier, the distributed key-value store communicatively coupled to a feature computation platform that generates aggregated features from event data streams; transmitting the inference request and the set of user features to an inference engine instance selected from a plurality of inference engine instances; hydrating, at the inference engine instance, a set of document features for each of the plurality of candidate content identifiers by accessing a local feature store co-located with the inference engine instance, the local feature store storing document features for a corpus of content items and the hydrating performed without issuing network calls to the distributed key-value store for document feature retrieval; executing, at the inference engine instance, a trained machine learning model to generate a relevance score for each of the plurality of candidate content identifiers based on the set of user features and the corresponding set of document features; and returning, from the inference engine instance, the relevance scores for the plurality of candidate content identifiers in response to the inference request.

In Example 10, the subject matter of Example 9 includes, wherein the feature computation platform generates the aggregated features by processing the event data streams over sliding time windows and grouping by entity keys, and wherein the aggregated features are stored in both an offline feature store for model training and the distributed key-value store for online inference serving.

In Example 11, the subject matter of Examples 9-10 includes, wherein the operations further comprise: routing, by the inference front end, the inference request to the inference engine instance based on a model co-location configuration that specifies which trained machine learning models are loaded on each of the plurality of inference engine instances, wherein the inference engine instance hosts a plurality of trained machine learning models simultaneously.

In Example 12, the subject matter of Examples 9-11 includes, wherein the operations further comprise: logging, by the inference engine instance, online prediction data comprising the relevance scores and associated feature values to an online prediction log store; and detecting, by a monitoring system, anomalies in the relevance scores or the associated feature values by comparing statistical measures of the online prediction data against expected distributions.

In Example 13, the subject matter of Example 12 includes, wherein the operations further comprise: performing, by the monitoring system, offline model rescoring using offline features from an offline feature store to generate offline relevance scores; and identifying, by the monitoring system, discrepancies between the relevance scores generated during online inference and the offline relevance scores generated during the offline model rescoring.

In Example 14, the subject matter of Examples 9-13 includes, wherein the trained machine learning model is generated by a training pipeline comprising: generating training data by pairing raw events containing engagement labels with aggregated features retrieved from an offline feature store; training the machine learning model using the training data on hardware accelerators comprising at least one of graphics processing units or tensor processing units; evaluating the trained machine learning model to generate model performance metrics; and exporting the trained machine learning model by generating hardware-optimized model versions for deployment to the plurality of inference engine instances.

In Example 15, the subject matter of Example 14 includes, wherein the training pipeline further comprises: performing automated hyperparameter tuning using Bayesian optimization to identify improved parameter values based on observed model performance metrics, wherein the parameter values comprise at least one of learning rate, batch size, or layer dimensions.

In Example 16, the subject matter of Examples 9-15 includes, wherein the operations further comprise: receiving, at the inference front end, a plurality of sub-requests for different trained machine learning models within a single remote procedure call; unbundling, by the inference front end, the plurality of sub-requests; batching, by the inference front end, sub-requests destined for a common inference engine instance; and routing the batched sub-requests to the common inference engine instance to reduce network overhead.

Example 17 is a non-transitory machine-readable medium storing instructions thereon, which, when executed by one or more processors, cause the one or more processors to perform operations comprising: receiving, at an inference front end of a machine learning platform, an inference request comprising a user identifier and a plurality of candidate content identifiers, the inference request specifying a ranking operation to score each of the plurality of candidate content identifiers relative to a user context associated with the user identifier; retrieving, from a distributed key-value store, a set of user features associated with the user identifier, the distributed key-value store communicatively coupled to a feature computation platform that generates aggregated features from event data streams; transmitting the inference request and the set of user features to an inference engine instance selected from a plurality of inference engine instances; hydrating, at the inference engine instance, a set of document features for each of the plurality of candidate content identifiers by accessing a local feature store co-located with the inference engine instance, the local feature store storing document features for a corpus of content items and the hydrating performed without issuing network calls to the distributed key-value store for document feature retrieval; executing, at the inference engine instance, a trained machine learning model to generate a relevance score for each of the plurality of candidate content identifiers based on the set of user features and the corresponding set of document features; and returning, from the inference engine instance, the relevance scores for the plurality of candidate content identifiers in response to the inference request.

In Example 18, the subject matter of Example 17 includes, wherein the feature computation platform generates the aggregated features by processing the event data streams over sliding time windows and grouping by entity keys, and wherein the aggregated features are stored in both an offline feature store for model training and the distributed key-value store for online inference serving.

In Example 19, the subject matter of Examples 17-18 includes, wherein the operations further comprise: routing, by the inference front end, the inference request to the inference engine instance based on a model co-location configuration that specifies which trained machine learning models are loaded on each of the plurality of inference engine instances, wherein the inference engine instance hosts a plurality of trained machine learning models simultaneously.

In Example 20, the subject matter of Examples 17-19 includes, wherein the operations further comprise: logging, by the inference engine instance, online prediction data comprising the relevance scores and associated feature values to an online prediction log store; and detecting, by a monitoring system, anomalies in the relevance scores or the associated feature values by comparing statistical measures of the online prediction data against expected distributions.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method for serving machine learning inference requests in a distributed computing environment, the method comprising:
receiving, at an inference front end of a machine learning platform, an inference request comprising a user identifier and a plurality of candidate content identifiers, the inference request specifying a ranking operation to score each of the plurality of candidate content identifiers relative to a user context associated with the user identifier;
retrieving, from a distributed key-value store, a set of user features associated with the user identifier, the distributed key-value store communicatively coupled to a feature computation platform that generates aggregated features from event data streams;
transmitting the inference request and the set of user features to an inference engine instance selected from a plurality of inference engine instances;
hydrating, at the inference engine instance, a set of document features for each of the plurality of candidate content identifiers by accessing a local feature store co-located with the inference engine instance, the local feature store storing document features for a corpus of content items and the hydrating performed without issuing network calls to the distributed key-value store for document feature retrieval;
executing, at the inference engine instance, a trained machine learning model to generate a relevance score for each of the plurality of candidate content identifiers based on the set of user features and the corresponding set of document features; and
returning, from the inference engine instance, the relevance scores for the plurality of candidate content identifiers in response to the inference request.

2. The method of claim 1, wherein the feature computation platform generates the aggregated features by processing the event data streams over sliding time windows and grouping by entity keys, and wherein the aggregated features are stored in both an offline feature store for model training and the distributed key-value store for online inference serving.

3. The method of claim 1, further comprising:
routing, by the inference front end, the inference request to the inference engine instance based on a model co-location configuration that specifies which trained machine learning models are loaded on each of the plurality of inference engine instances, wherein the inference engine instance hosts a plurality of trained machine learning models simultaneously.

4. The method of claim 1, further comprising:
logging, by the inference engine instance, online prediction data comprising the relevance scores and associated feature values to an online prediction log store; and
detecting, by a monitoring system, anomalies in the relevance scores or the associated feature values by comparing statistical measures of the online prediction data against expected distributions.

5. The method of claim 4, further comprising:
performing, by the monitoring system, offline model rescoring using offline features from an offline feature store to generate offline relevance scores; and
identifying, by the monitoring system, discrepancies between the relevance scores generated during online inference and the offline relevance scores generated during the offline model rescoring.

6. The method of claim 1, wherein the trained machine learning model is generated by a training pipeline comprising:
generating training data by pairing raw events containing engagement labels with aggregated features retrieved from an offline feature store;
training the machine learning model using the training data on hardware accelerators comprising at least one of graphics processing units or tensor processing units;
evaluating the trained machine learning model to generate model performance metrics; and
exporting the trained machine learning model by generating hardware-optimized model versions for deployment to the plurality of inference engine instances.

7. The method of claim 6, wherein the training pipeline further comprises:
performing automated hyperparameter tuning using Bayesian optimization to identify improved parameter values based on observed model performance metrics, wherein the parameter values comprise at least one of learning rate, batch size, or layer dimensions.

8. The method of claim 1, further comprising:
receiving, at the inference front end, a plurality of sub-requests for different trained machine learning models within a single remote procedure call;
unbundling, by the inference front end, the plurality of sub-requests;
batching, by the inference front end, sub-requests destined for a common inference engine instance; and
routing the batched sub-requests to the common inference engine instance to reduce network overhead.

9. A system for serving machine learning inference requests in a distributed computing environment, the system comprising:
one or more processors; and
one or more memory storage devices storing instructions thereon, which, when executed by the one or more processors, cause the system to perform operations comprising:
receiving, at an inference front end of a machine learning platform, an inference request comprising a user identifier and a plurality of candidate content identifiers, the inference request specifying a ranking operation to score each of the plurality of candidate content identifiers relative to a user context associated with the user identifier;
retrieving, from a distributed key-value store, a set of user features associated with the user identifier, the distributed key-value store communicatively coupled to a feature computation platform that generates aggregated features from event data streams;
transmitting the inference request and the set of user features to an inference engine instance selected from a plurality of inference engine instances;
hydrating, at the inference engine instance, a set of document features for each of the plurality of candidate content identifiers by accessing a local feature store co-located with the inference engine instance, the local feature store storing document features for a corpus of content items and the hydrating performed without issuing network calls to the distributed key-value store for document feature retrieval;
executing, at the inference engine instance, a trained machine learning model to generate a relevance score for each of the plurality of candidate content identifiers based on the set of user features and the corresponding set of document features; and
returning, from the inference engine instance, the relevance scores for the plurality of candidate content identifiers in response to the inference request.

10. The system of claim 9, wherein the feature computation platform generates the aggregated features by processing the event data streams over sliding time windows and grouping by entity keys, and wherein the aggregated features are stored in both an offline feature store for model training and the distributed key-value store for online inference serving.

11. The system of claim 9, wherein the operations further comprise:
routing, by the inference front end, the inference request to the inference engine instance based on a model co-location configuration that specifies which trained machine learning models are loaded on each of the plurality of inference engine instances, wherein the inference engine instance hosts a plurality of trained machine learning models simultaneously.

12. The system of claim 9, wherein the operations further comprise:
logging, by the inference engine instance, online prediction data comprising the relevance scores and associated feature values to an online prediction log store; and
detecting, by a monitoring system, anomalies in the relevance scores or the associated feature values by comparing statistical measures of the online prediction data against expected distributions.

13. The system of claim 12, wherein the operations further comprise:
performing, by the monitoring system, offline model rescoring using offline features from an offline feature store to generate offline relevance scores; and
identifying, by the monitoring system, discrepancies between the relevance scores generated during online inference and the offline relevance scores generated during the offline model rescoring.

14. The system of claim 9, wherein the trained machine learning model is generated by a training pipeline comprising:
generating training data by pairing raw events containing engagement labels with aggregated features retrieved from an offline feature store;
training the machine learning model using the training data on hardware accelerators comprising at least one of graphics processing units or tensor processing units;
evaluating the trained machine learning model to generate model performance metrics; and
exporting the trained machine learning model by generating hardware-optimized model versions for deployment to the plurality of inference engine instances.

15. The system of claim 14, wherein the training pipeline further comprises:
performing automated hyperparameter tuning using Bayesian optimization to identify improved parameter values based on observed model performance metrics, wherein the parameter values comprise at least one of learning rate, batch size, or layer dimensions.

16. The system of claim 9, wherein the operations further comprise:
receiving, at the inference front end, a plurality of sub-requests for different trained machine learning models within a single remote procedure call;
unbundling, by the inference front end, the plurality of sub-requests;
batching, by the inference front end, sub-requests destined for a common inference engine instance; and
routing the batched sub-requests to the common inference engine instance to reduce network overhead.

17. A non-transitory machine-readable medium storing instructions thereon, which, when executed by one or more processors, cause the one or more processors to perform operations comprising:
receiving, at an inference front end of a machine learning platform, an inference request comprising a user identifier and a plurality of candidate content identifiers, the inference request specifying a ranking operation to score each of the plurality of candidate content identifiers relative to a user context associated with the user identifier;
retrieving, from a distributed key-value store, a set of user features associated with the user identifier, the distributed key-value store communicatively coupled to a feature computation platform that generates aggregated features from event data streams;
transmitting the inference request and the set of user features to an inference engine instance selected from a plurality of inference engine instances;
hydrating, at the inference engine instance, a set of document features for each of the plurality of candidate content identifiers by accessing a local feature store co-located with the inference engine instance, the local feature store storing document features for a corpus of content items and the hydrating performed without issuing network calls to the distributed key-value store for document feature retrieval;
executing, at the inference engine instance, a trained machine learning model to generate a relevance score for each of the plurality of candidate content identifiers based on the set of user features and the corresponding set of document features; and
returning, from the inference engine instance, the relevance scores for the plurality of candidate content identifiers in response to the inference request.

18. The non-transitory machine-readable medium of claim 17, wherein the feature computation platform generates the aggregated features by processing the event data streams over sliding time windows and grouping by entity keys, and wherein the aggregated features are stored in both an offline feature store for model training and the distributed key-value store for online inference serving.

19. The non-transitory machine-readable medium of claim 17, wherein the operations further comprise:
routing, by the inference front end, the inference request to the inference engine instance based on a model co-location configuration that specifies which trained machine learning models are loaded on each of the plurality of inference engine instances, wherein the inference engine instance hosts a plurality of trained machine learning models simultaneously.

20. The non-transitory machine-readable medium of claim 17, wherein the operations further comprise:
logging, by the inference engine instance, online prediction data comprising the relevance scores and associated feature values to an online prediction log store; and
detecting, by a monitoring system, anomalies in the relevance scores or the associated feature values by comparing statistical measures of the online prediction data against expected distributions.
